(19) United States
(12) Patent Application Publication
(10) Pub. No.: US 2013/0215471 A1
(43) Pub. Date: Aug. 22, 2013

(54) DETERMINING IMPOSITION OF PRINTABLE OBJECTS

(71) Applicant: Ron Banner, Yokneam (IL)

(72) Inventor: Ron Banner, Yokneam (IL)

(73) Assignee: Hewlett-Packard Development Company, L.P., Houston, TX (US)

(21) Appl. No.: 13/882,179

(22) PCT Filed: Oct. 29, 2010
(86) PCT No.: PCT/US10/54796

§ 371 Date: Apr. 27, 2013

(51) Int. Cl. G06F 3/12

(52) U.S. Cl. CPC G06F 3/1219
USPC 358/1.18

(57) ABSTRACT

Determining imposition of printable objects (105, 110, 115, 120, and 125) with variable dimensions. A plurality of printable objects (105, 110, 115, 120 and 125) are received (202), at a computer system, to be printed on a medium, wherein the plurality of printable objects comprise a plurality of dimensions. A print layout (150) is determined (204), at the computer system, for the plurality of printable objects such that the print layout comprises a plurality of sub layouts (155 and 160) wherein each of the plurality of sub layouts comprises at least one printable object and wherein at least one sub layout can be separated from the plurality of the sub layouts using an end to end cut of the medium that parallels an edge of the medium.

### FIELD

Embodiments of the present invention relate generally to determining the imposition of printable objects on a medium.

### BACKGROUND

Commercial printers often use large sheets of paper that they fold, cut, and trim to the finished size. Imposition is the task of printing multiple jobs on a single sheet of paper in a particular order so that they come out in the correct sequence when cut and folded. The increasing trend of occupying low-cost operators with no tradition of dealing with imposition and little technical appreciation of the requirements, dictate current demands from digital printers to look for low-cost solutions that can simplify imposition appropriate for various requirements.

### BRIEF DESCRIPTION OF THE DRAWINGS

FIG. 1 illustrates a block diagram of imposition layouts in accordance with embodiments of the present technology.

FIG. 2 illustrates a flowchart of an example method for determining imposition of printable objects with variable dimensions in accordance with embodiments of the present technology.

FIG. 3 illustrates a flowchart of an example method for determining imposition of printable objects with variable dimensions in accordance with embodiments of the present technology.

The drawings referred to in this description of embodiments should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “receiving”, “determining”, “sorting,” “modifying”, or the like, refer to the actions and processes of a computer system, printer or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, optical and mechanical computers.

### Overview of Discussion

Embodiments of the present technology utilize processes and methods, which may include the use of algorithms, which are used to determine the layout or imposition of printable objects on a medium where the printable objects have various dimensions.

Imposition is the task of printing multiple jobs on a single sheet of paper in a particular order so that they come out in the correct sequence when cut and folded. This task is increasingly being integrated into the pre-press workflow, so automatically choosing an appropriate solution becomes more important for providing the tools to intelligently handle the process. This together with the increasing trend of occupying low-cost operators with no tradition of dealing with imposition and little technical appreciation of the requirements, dictate current demands from digital printers to look for low-cost solutions that can simplify or automate imposition appropriate for their sheet size, run lengths and turn-round times.

In essence, the imposition task involves a subtask, known by ganging, that aims at minimizing trim waste. Some products can be driven by a script to provide automated fixed impositions for uniformly sized ganged elements like business cards. These elements are laid on a single sheet and are later separated by end-to-end cuts that are parallel to the edge of the sheet (guillotine cuts). It has been shown that these simple strategies of ganging several printable objects, or jobs, together on the same sheet can substantially save running time and paper. Unfortunately, achieving the optimal layout for the ganging of multiple jobs on a single sheet where the size of the jobs varies is highly challenging.

Various embodiments of the present technology create optimization methods for the imposition of printable objects with variable dimensions. Two objectives of the present technology are (1) to optimize the use of raw materials in the printing process, namely reducing the number of sheets used in the process and (2) to optimize operator effort and labor by reducing the number of cuts needed to separate between the jobs.

In one embodiment, guillotine cuts (end-to-end cuts parallel to the edge of the medium) are employed to separate printable objects after printing. Therefore, imposition techniques of the present technology determine layouts and sub layouts that allow for guillotine cuts. In one embodiment, imposition techniques of the present technology allow the printable objects to be rotated by 90 degrees when determining layouts and sub layouts.

The following discussion will demonstrate various hardware, software, and firmware components that are used with and in printers, devices and computer systems used for determining the imposition of printable objects on a medium using various embodiments of the present technology. Furthermore, the printers, devices, computer systems and their methods may include some, all, or none of the hardware, software, and firmware components discussed below.

### Embodiments of Determining the Imposition of Printable Objects

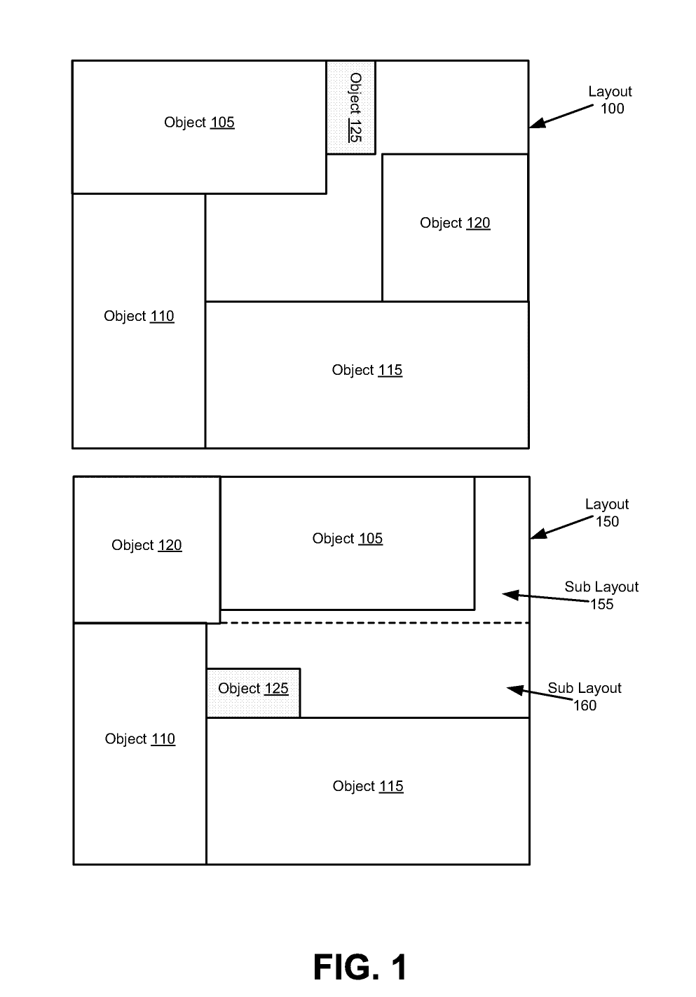

With reference now to FIG. 1, a block diagram of example layouts of printable objects. Layout 100 and Layout 150 includes object 105, object 110, object 115, object 120 and object 125. Layout 100 and Layout 150 should not be construed to limit the present technology.

Objects 105, 110, 115, 120 and 125 represent printable objects, each composes of different dimensions, in accordance with embodiments of the present technology. A printable object may also be known in the art as a job or print job. Printable objects include, but are not limited to, images, photos, photo albums, text, business cards, documents, etc. The present technology may be employed using a variety of printing technology. For example, the printable objects may be printed on a printer, a digital printer, a printing press, etc. Various mediums may also be used in which to print on, such as paper, photo paper, card stock, etc. Processes used by the present technology for determining the imposition of printable objects on a medium may take place on a computer system independent of the printer used to print the printable objects onto the medium. In one embodiment, processors, circuits and other hardware associated with a printer may be used for determining the imposition of printable objects on a medium.

Layout 100 illustrates a potential layout of objects 105, 110, 115, 120 and 125. In layout 100, the objects are positioned in a manner that would not allow a guillotine cut of the medium without cutting though one of the objects. For example, a guillotine cut that would separate object 105 and object 110 would cut through object 120. Therefore, layout 100 represents a layout that is unacceptable for guillotine cuts. Guillotine cuts are desirable to increase the efficiency of separating printable objects that are printed on the same medium and need to be separated. Various technology solutions exist for creating guillotine cuts and may be used with embodiments of the present technology.

Layout 150 illustrates a different potential layout of objects 105, 110, 115, 120 and 125. In layout 150, the objects are positioned in a manner that would allow a guillotine cut of the medium without cutting though one of the objects. For example, a guillotine cut that would separate object 120 and object 110 would not pass through any other objects. The dotted line layout 150 serves to demonstrate that such a guillotine cut would separate object 120 and object 110 and would then only cut through portions of the medium that do not contain printable objects.

Layout 150 also comprises sub layouts 155 and 160. Sub layout 155 comprises objects 120 and 105 while sub layout 160 comprises objects 110, 115 and 125. It should be noted that both sub layouts 155 and 160 include unused portion of the medium that may be referred to as trim. Once sub layout 155 is separated using a guillotine cut, object 120 may be separated from object 105 using a guillotine cut. Object 105 may then be separated from the trim using two more guillotine cuts.

The objects in sub layout 160 may then be separated using similar guillotine cut techniques. In one embodiment, a layout may be comprised of sub layouts and sub sub layouts. For example, a sub layout may comprise four printable objects. That sub layout may be comprised of two sub sub layouts each of which comprise two printable objects. It should be appreciated that a layout for a given medium is not limited by the number of printable objects, sub layouts, or iterative sub layouts within sub layouts.

In determining a layout, the present technology may rotate a printable object 90 degrees. For example, the position of object 120 in layout 100 is rotated 90 degrees relative to its position in layout 150.

One goal of the present technology is to limit the quantity of a medium used to print the printable objects. However, this goal may be offset by the manageability of a given imposition. For example, an imposition may include n number of objects that are comprised of three different dimensions. The imposition may layout the objects in a manner that will include the most objects on a single medium. However, a more manageable approach may place objects of the same dimensions next to each other on the single medium thus allowing two guillotine cuts to separate the medium into three pieces where each piece has objects of only one dimension. This allows an optimal solution for allowing n objects to be separated using the fewest cuts. In one embodiment, it may be said that the solution is manageable if n jobs on the same medium can be separated using at most n guillotine cuts (i.e., each printable object can be separated from its “neighboring” printable objects by a single cut).

In one embodiment, the optimal manageability is achieved by sorting printable objects in a non-decreasing order. Hence, printable objects of the same dimension are considered by the algorithm in consecutive iterations.

In one embodiment, the processes of the present technology employ algorithms for the layout determination. In one embodiment, algorithms termed two-dimensional bin packing may be used for part of the layout determination. In two-dimensional bin packing, there are n printable objects each with a width w and a height h. In one embodiment, a printable object may be rotated 90 degrees during the layout determination thus interchanging the width w and height h of the object. Therefore more permutations for the layout may be discovered in the process.

Algorithms used by the present technology are computationally fast. For example, in one embodiment, the complexity of a sorting algorithm may be O (N*log N).

In the art, a basic solution to the two-dimensional bin packing problem is the first-fit decreasing policy which is described as follows. At the first step all items are sorted in a non-decreasing order according to their heights. The current item is then packed into the first bin which can accommodate it, or on the bottom of a new one, if no such bin exists; in the former case the item is packed onto the first existing shelf which can accommodate it, or by initializing a new one if no such shelf exists. Such techniques may be applied to the present technology.

The first fit decreasing policy is investigated in Equation 1. Given an instance I of the bin packing problem, denote by FFD(I) the number of pages that are needed in a solution obtained by the first fit decreasing policy and denote by OPT(I) the number of pages that are needed according to the optimal solution. Thus, it is shown in Equation 1 that

FFD(I)≦(17/10)·OPT(I)+1 Equation 1

However, this solution to the two-dimensional bin packing problem does not account for the use of guillotine cuts of a printable medium. Accordingly, it must be verified that the arrangement of items obtained by FFD(I) can be separated using end to end cuts that parallel an edge of the medium. Yet, it is easy to see that these arrangements preserve the guillotine constraints since they are organized according to shelves; hence, it is always possible to separate the shelves from each other (using end-to-end cuts) and then separate all the jobs that belong to the same shelf. In other words, the solution obtained by Algorithm FFD(I) provides a feasible solution for guillotine cuts. On the other hand, since imposing the guillotine constraints can only restrict the space of feasible solutions it holds that

OPT(I)≦OPT_{guillotine}(I) Equation 2

where OPT_{guillotine} is the optimal solution obtained for the case where the guillotine requirement is enforced. Thus, from Equation 1 and Equation 2 it follows that

FFD(I)≦(17/10)·OPT_{guillotine}(I)+1 Equation 3

Thus embodiments of the present technology increase the efficiency of imposition layouts by reducing the quantity of medium used, the number of cuts, the run time of the print operation and the labor of the operator.

### Operation

More generally, in embodiments in accordance with the present invention, are for determining imposition of printable objects with variable dimensions. Such methods can be implemented using computer system associated with printer.

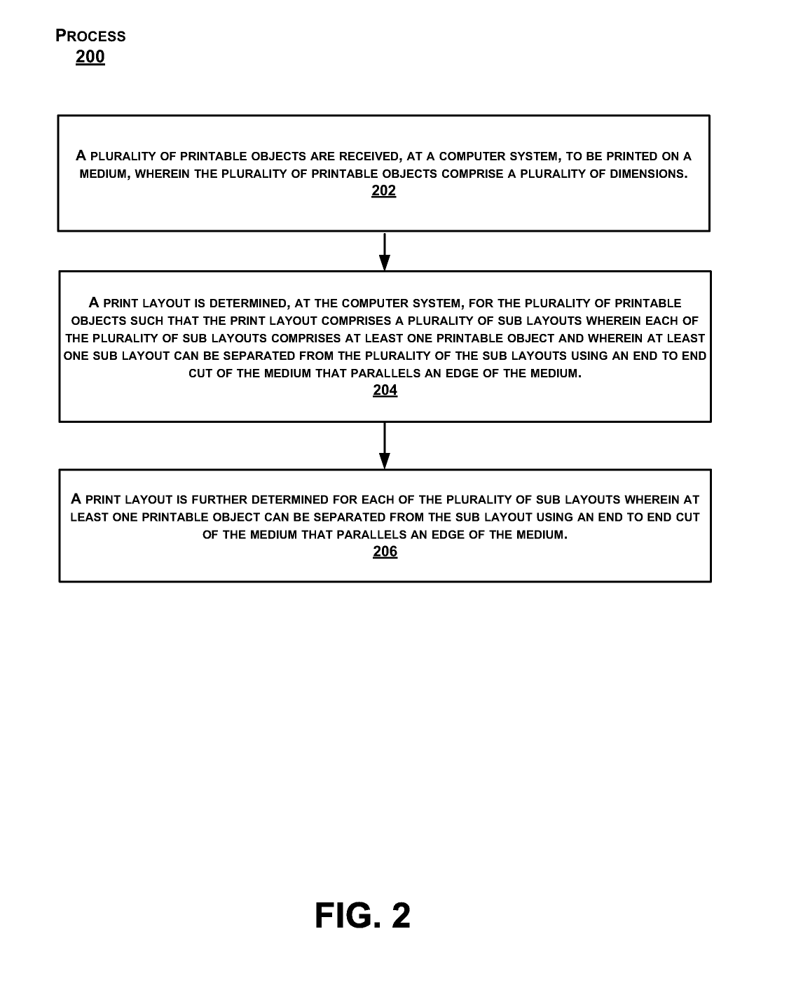

FIG. 2 is a flowchart illustrating process 200 for determining imposition of printable objects with variable dimensions, in accordance with one embodiment of the present invention. In one embodiment, process 200 is carried out by processors and electrical components under the control of computer readable and computer executable instructions stored on a computer-usable storage medium. The computer readable and computer executable instructions reside, for example, in data storage features such as computer usable volatile and non-volatile memory. The computer usable medium may be non-transitory. However, the computer readable and computer executable instructions may reside in any type of computer-usable storage medium.

In one embodiment, process 200 is used to determining imposition of printable objects with variable dimensions. It should be appreciated that the steps of process 200 may not need to be executed in the order they are listed in. Additionally, embodiments of the present technology do not require that all of the steps of process 200 be executed to determining imposition of printable objects with variable dimensions. At step 202, a plurality of printable objects are received, at a computer system, to be printed on a medium, wherein the plurality of printable objects comprise a plurality of dimensions.

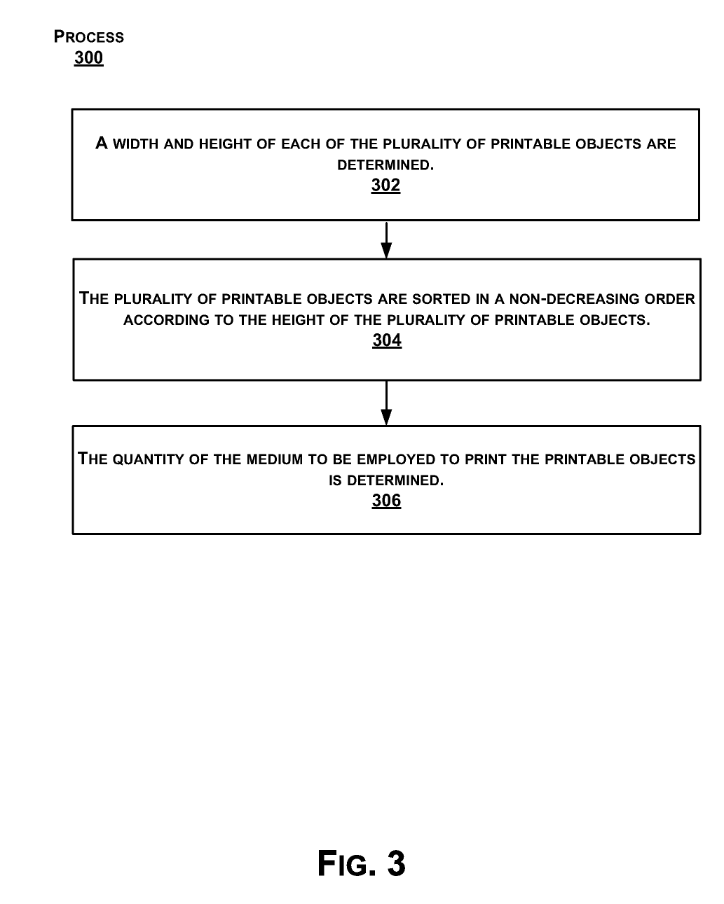

At step 204, a print layout is determined, at the computer system, for the plurality of printable objects such that the print layout comprises a plurality of sub layouts wherein each of the plurality of sub layouts comprises at least one printable object and wherein at least one sub layout can be separated from the plurality of the sub layouts using an end to end cut of the medium that parallels an edge of the medium. In one embodiment, the print layout is further determined using the step of process 300 of FIG. 3. In one embodiment, the printable objects may be rotated 90 degrees to interchange the width and height of said printable objects.

At step 206, a print layout is further determined for each of the plurality of sub layouts wherein at least one printable object can be separated from the sub layout using an end to end cut of the medium that parallels an edge of the medium. In one embodiment, the sub layouts further comprise sub sub layouts.

FIG. 3 is a flowchart illustrating process 300 for determining imposition of printable objects with variable dimensions, in accordance with one embodiment of the present invention. In one embodiment, process 300 is carried out by processors and electrical components under the control of computer readable and computer executable instructions stored on a computer-usable storage medium. The computer readable and computer executable instructions reside, for example, in data storage features such as computer usable volatile and non-volatile memory. The computer usable medium may be non-transitory. However, the computer readable and computer executable instructions may reside in any type of computer-usable storage medium.

In one embodiment, process 300 is used to determining imposition of printable objects with variable dimensions. It should be appreciated that the steps of process 300 may not need to be executed in the order they are listed in. Additionally, embodiments of the present technology do not require that all of the steps of process 300 be executed to determining imposition of printable objects with variable dimensions.

At step 302, a width and height of each of the plurality of printable objects are determined.

At step 304, the plurality of printable objects are sorted in a non-decreasing order according to the height of the plurality of printable objects.

At step 306, the quantity of the medium to be employed to print the printable objects is determined.

1. A method for determining imposition (100 and 150) of printable objects (105, 110, 115, 120 and 125) with variable dimensions, said method comprising:
receiving (202) a plurality of printable objects (105, 110, 115, 120 and 125), at a computer system, to be printed on a medium, wherein said plurality of printable objects comprise a plurality of dimensions; and
determining (204) a print layout (150), at said computer system, for said plurality of printable objects such that said print layout comprises a plurality of sub layouts (155 and 160) wherein each of said plurality of sub layouts comprises at least one printable object and wherein at least one sub layout can be separated from said plurality of said sub layouts using an end to end cut of said medium that parallels an edge of said medium.

2. The method of claim 1, further comprising:
further determining (206) a print layout (150) for each of said plurality of sub layouts (155 and 160) wherein at least one printable object can be separated from said sub layout using an end to end cut of said medium that parallels an edge of said medium.

3. The method of claim 2 wherein at least one of said plurality of sub layouts (155 and 160) comprises a plurality of printable objects.

4. The method of claim 1 wherein said determining a print layout further comprises:
determining (302) a width and height of each of said plurality of printable objects;
sorting (304) said plurality of printable objects in a non-decreasing order according to the height of said plurality of printable objects; and
determining (306) the quantity of said medium to be employed to print said printable objects.

5. The method of claim 4 wherein said sorting said plurality of printable objects (105, 110, 115, 120 and 125) allows said printable objects to be rotated 90 degrees to interchange the width and height of said printable objects.

6. The method of claim 1 wherein said plurality of printable objects (105, 110, 115, 120 and 125) comprises at least two printable objects that have the same dimensions and a third printable object of different dimensions.

7. The method of claim 1 wherein said plurality of sub layouts (155 and 160) comprises at least one sub layout with a plurality of printable objects that require a sub sub layout of said sub layout.

8. A computer-usable storage medium having instructions embodied therein that when executed cause a computer system to perform a method for determining imposition (100 and 150) of printable objects (105, 110, 115, 120 and 125) with variable dimensions, said method comprising:
receiving (202) a plurality of printable objects (105, 110, 115, 120 and 125), at a computer system, to be printed on a medium, wherein said plurality of printable objects comprise a plurality of dimensions; and
determining (204) a print layout (150), at said computer system, for said plurality of printable objects such that said print layout comprises a plurality of sub layouts (155 and 160) wherein each of said plurality of sub layouts comprises at least one printable object and wherein at least one sub layout can be separated from said plurality of said sub layouts using an end to end cut of said medium that parallels an edge of said medium; and
further determining (206) a print layout (150) for each of said plurality of sub layouts (155 and 160) wherein at least one printable object can be separated from said sub layout using an end to end cut of said medium that parallels an edge of said medium.

9. The computer-usable storage medium of claim 8 wherein said determining a print layout further comprises:
determining (302) a width and height of each of said plurality of printable objects;
sorting (304) said plurality of printable objects in a non-decreasing order according to the height of said plurality of printable objects; and
determining (306) the quantity of said medium to be employed to print said printable objects.

10. The computer-usable storage medium of claim 8 wherein said sorting said plurality of printable objects (105, 110, 115, 120 and 125) allows said printable objects to be rotated 90 degrees to interchange the width and height of said printable objects.

11. The computer-usable storage medium of claim 8 wherein said plurality of printable objects (105, 110, 115, 120 and 125) comprises at least two printable objects that have the same dimensions and a third printable object of different dimensions.

12. The computer-usable storage medium of claim 8 wherein at least one of said plurality of sub layouts (155 and 160) comprises a plurality of printable objects.

13. The computer-usable storage medium of claim 8 wherein said plurality of sub layouts (155 and 160) comprises at least one sub layout with a plurality of printable objects that require a sub sub layout of said sub layout.

14. A method for determining imposition (100 and 150) of printable objects (105, 110, 115, 120 and 125) with variable dimensions, said method comprising:
receiving (202) a plurality of printable objects (105, 110, 115, 120 and 125), at a computer system, to be printed on a medium, wherein said plurality of printable objects comprise a plurality of dimensions; and
determining (204) a print layout (150), at said computer system, for said plurality of printable objects such that said print layout comprises a plurality of sub layouts (155 and 160) wherein each of said plurality of sub layouts comprises at least one printable object and wherein at least one sub layout can be separated from said plurality of said sub layouts using an end to end cut of said medium that parallels an edge of said medium, wherein said determining further comprises:
determining (302) a width and height of each of said plurality of printable objects;
sorting (304) said plurality of printable objects in a non-decreasing order according to the height of said plurality of printable objects; and
determining (306) the quantity of said medium to be employed to print said printable objects.

15. The method of claim 14 wherein said sorting said plurality of printable objects (105, 110, 115, 120 and 125) allows said printable objects to be rotated 90 degrees to interchange the width and height of said printable objects.
